(19) United States
(12) Patent Application Publication
(10) Pub. No.: US 2008/0137512 A1
(43) Pub. Date: Jun. 12, 2008

(54) Holographic information recording/reproducing apparatus and method for seeking books in the same

(75) Inventors: Jong-chul Chol, Suwon-si (KR); Taek-seong Jeong, Suwon-si (KR); Moon-Il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/783,606

(22) Filed: Apr. 10, 2007

(30) Foreign Application Priority Data
Dec. 7, 2006 (KR) 2006-124045

(51) Int. Cl. G11B 7/00

(52) U.S. Cl. 369/103

(57) ABSTRACT

Provided are a holographic information recording/reproducing apparatus in which positions of books can be accurately ascertained in a holographic recording medium, and a method for seeking books in the same. The apparatus includes an aperture plate disposed in an optical path of a signal beam reproduced from a reference beam that is incident on a holographic recording medium, and having an opening for restricting a width of the signal beam; one or more photodetectors installed on a surface of the aperture plate along a circumference of the opening; and a book position calculator to calculate positions of one or more books from the output of the photodetectors, wherein a cross-section of the reference beam incident on the holographic recording medium is larger than the size of the one or more books.

### CROSS-REFERENCE TO RELATED APPLICATION

This application claims all benefits accruing under 35 U.S.C. §119 from Korean Patent Application No. 2006-124045, filed on Dec. 7 2006, in the Korean Intellectual Property Office, the disclosure of which incorporated herein by reference.

### BACKGROUND OF THE INVENTION

1. Field of the Invention

The present invention relates to a holographic information recording/reproducing apparatus and a method for seeking books in the same, and more particularly, to a holographic information recording/reproducing apparatus in which positions of books can be accurately ascertained in a holographic recording medium, and a method for seeking books in the same.

2. Description of the Related Art

Hologram or holographic technology can reproduce an optical signal from a stereoscopic image that has been recorded on a holographic recording medium using an interference pattern between a signal beam which carries a signal and a reference beam that is incident at a different angle to the signal beam. Optical storage technology to record and reproduce digital data using principles of holographic technology has recently been highlighted. Holographic information recording and reproducing technology allows recording and reproducing of information in units of pages by which a plurality of digital data are simultaneously recorded/reproduced (i.e., recorded and/or reproduced) in the shape or form of a two-dimensional image. Thus, an ultra-high speed recording/reproducing system can be implemented. In addition, the holographic optical storage technology can even separate and read information which are spatially overlapped and stored by use of a proper multiplexing technique. Thus, data information of several pages can be recorded in overlapping manner and be reproduced from the same region.

FIG. 1A illustrates recording of information using a typical holographic information recording/reproducing apparatus. As illustrated in FIG. 1A, a beam splitter 2 splits a laser beam 1 into a reference beam 6 and a signal beam 5. The signal beam 5 passes through a spatial light modulator (SLM) 4, is modulated into a two-dimensional signal pattern, and is then incident on a holographic recording medium M. As shown, an aperture plate A may be disposed in the optical path of the signal beam 5 passing through the spatial light modulator (SLM) 4, so that only a desired signal beam (or portions thereof) can be incident on the holographic recording medium M. Meanwhile, the reference beam 6 is reflected by a mirror 3 and is incident on the holographic recording medium M at an angle, causing the reference beam 6 to interfere with the signal beam 5. As a result, an interference pattern is formed and is then recorded in the holographic recording medium M.

FIG. 1B illustrates the reproducing of recorded information using a typical holographic information recording/reproducing apparatus. When information is to be reproduced, the holographic recording medium M is irradiated with a reference beam 6′ emitted from a light source such as a laser 8, having the same wavelength as that of the reference beam 6 shown in FIG. 1A. Here, reference beam 6′ should be incident on the holographic recording medium M at the same angle of incidence used to record information as described in FIG. 1A. Then, a signal beam 7 having a two-dimensional signal pattern containing original data information is generated as the reference beam 6′ is diffracted on the holographic recording medium M. The signal beam 7 is condensed by a lens 9 and is then detected by a two-dimensional photodetector 10, such as a charge coupled device (CCD). In the above case, the aperture plate A is disposed in the optical path of the signal beam 7 so that only a desired signal thereof can be detected by the photodetector 10, and the other signals can be cut off.

Such a typical holographic information recording/reproducing apparatus records a two-dimensional signal in predetermined units in a holographic recording medium M. In general, a two-dimensional region for information recording in and reproducing from a holographic recording medium M is referred to as a book, which is also a unit. Information of several pages (which is also a unit) may be recorded in one book using a multiplexing technique. In order to increase a recording density of the books in the holographic recording medium M, it is important to minimize the distance between the books within the holographic recording medium M.

Meanwhile, when information is recorded in and reproduced from the holographic recording medium M, positions of the books within the holographic recording medium need to be accurately ascertained. To this end, a technology to seek the positions of the books has been suggested by attaching a cover glass having prepits formed thereon to the holographic recording medium or by forming a prepit structure directly on a recording layer of the holographic recording medium. The positions of the books are determined by detecting the prepits during the recording and reproducing operations. However, since the typical technology using prepits requires forming the additional prepit structure in the glass cover or the holographic recording medium, a process to manufacture the holographic recording medium becomes more complicated and costly. Furthermore, in order to detect the prepits, an additional optical system to detect the prepits, as well as a recording/reproducing optical system to detect the prepits is needed. Thus, the structure of the holographic information recording/reproducing apparatus becomes more complicated.

### SUMMARY OF THE INVENTION

The present invention provides a holographic information recording/reproducing apparatus in which positions of books can be accurately sought (ascertained or determined) in a holographic recording medium without using a prepit structure, and a method for seeking books in the same.

Additional aspects and/or advantages of the invention will be set forth in part in the description which follows and, in part, will be obvious from the description, or may be learned by practice of the invention.

According to an embodiment of the present invention, a holographic information recording/reproducing apparatus includes an aperture plate disposed in an optical path of a signal beam reproduced from a reference beam that is incident on a holographic recording medium, and having an opening for restricting a width of the signal beam; one or more photodetectors installed on a surface of the aperture plate along a circumference of the opening; and a book position calculator to calculate positions of one or more books from the output of the photodetectors, wherein a cross-section of the reference beam incident on the holographic recording medium is larger than the size of the one or more books.

According to aspects of the present invention, photodetectors are disposed respectively in positions that are perpendicular to one another relative to the opening. The photodetectors are respectively disposed on opposite sides of the opening along a first direction, and on opposite sides of the opening along a second direction that is perpendicular to the first direction. The photodetectors has two segments arranged symmetrically on the surface of the aperture plate.

According to aspects of the present invention, the book position calculator calculates a book position error from a difference in the intensities of the signal beam respectively measured by the two segments. The book position calculator calculates the book position error in perpendicular directions using the photodetectors that are disposed perpendicularly to one another.

According to aspects of the present invention, the photodetectors each has four segments arranged symmetrically on the surface of the aperture plate.

According to aspects of the present invention, the book position calculator calculates a book position error in a second direction perpendicular to a first direction from a difference between the sum of the intensities of the signal beam measured by two of the four segments that are arranged along a first direction and the sum of the intensities of the signal beam measured by the other two of the four segments that are arranged along the first direction, and calculates a book position error in the first direction from a difference between the sum of the intensities of the signal beam measured by two of the four segments that are arranged along the second direction and the sum of the intensities of the signal beam measured by the other two of the four segments that are arranged along the second direction.

According to aspects of the present invention, the photodetectors are two-dimensional photodetectors.

According to aspects of the present invention, book position calculator calculates a tilt error of the holographic recording medium from a difference in sizes of optical spots respectively measured by two segments of each of the two-dimensional photodetectors respectively disposed on opposite sides of the opening.

According to another embodiment of the present invention, a method of seeking positions of books of a holographic recording medium in a holographic information recording/reproducing apparatus includes: generating a signal beam from a reference beam that is incident on a holographic recording medium, and having a larger cross-section than a size of one of the books; detecting the signal beam generated from the books that are adjacent to a desired book to be ascertained, using one or more photodetectors; and calculating a book position error from the output of the photodetector, wherein the photodetectors are installed on a surface of an aperture plate along a circumference of an opening of the aperture plate for restricting a width of the signal beam.

According to another embodiment of the present invention, a method of seeking positions of books to be recorded on a disc-shaped holographic recording medium includes recording one of the books in the holographic recording medium; generating a signal beam from a reference beam having a larger cross-section than a size of one of the books on a holographic recording medium; detecting the signal beam generated from one of the books that is recorded just prior to the detecting of the signal beam, using one or more photodetectors; and determining a position of a book to be recorded next, from an output of the photodetectors, wherein the photodetectors are installed on a surface of an aperture plate along a circumference of an opening of the aperture plate for restricting a width of the signal beam.

According to another embodiment of the present invention, an apparatus to record and/or reproduce a book to/from a disc-shaped holographic recording medium includes: a light source to emit a reference beam and a signal beam having a larger cross-section than a size of a preexisting book on the holographic recording medium; an aperture plate disposed in an optical path of the signal beam and having an opening for restricting a width of the signal beam; photodetectors installed on a surface of the aperture plate along a circumference of the opening; and a book detector to detect the presence of the preexisting book through the signal beam generated from the preexisting book based on an output from the photodetectors, and determine a position of a book to be recorded and/or reproduced next from the detected presence of the preexisting book.

According to another embodiment of the present invention, a method of recording and/or reproducing a book to/from a disc-shaped holographic recording medium includes: generating a reference beam and a signal beam having a larger cross-section than a size of a preexisting book on the holographic recording medium; detecting the presence of the preexisting book through the signal beam generated from the preexisting book by using an output of a photodetector; determining a position of a book to be recorded and/or reproduced next from the detected presence of the preexisting book; and recording and/or reproducing the book, wherein the photodetectors are installed on a surface of an aperture plate along a circumference of an opening of the aperture plate for restricting a width of the signal beam.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A and 1B illustrate a typical holographic information recording/reproducing apparatus using hologram or holographic technology;

FIG. 2 schematically illustrates the structure of an aperture plate of a holographic information recording/reproducing apparatus according to an example embodiment of the present invention;

FIG. 3 illustrates a method for seeking positions of books using the aperture plate of FIG. 2 according to an example embodiment of the present invention;

FIG. 4 schematically illustrates the structure of an aperture plate having a four-divided (or quad) photodetector of a holographic information recording/reproducing apparatus according to another example embodiment of the present invention;

FIG. 5 illustrates a method for seeking positions of books using the aperture plate of FIG. 4 according to another example embodiment of the present invention;

FIGS. 6A and 6B illustrate a method for seeking positions of books during a recording operation according to another example embodiment of the present invention;

FIGS. 7A and 7B illustrate a concentric circular track and a spiral track formed in a holographic recording medium, respectively;

FIG. 8 illustrates a method for changing radial positions of books recorded in a spiral track according to an example embodiment of the present invention;

FIG. 9 illustrates a method for seeking positions of books during a reproducing operation according to another example embodiment of the present invention;

FIG. 10 is a graph showing a difference in the intensities of signal beams detected in two segments of a two-divided (or paired) photodetector according to a change in positions of books; and

FIG. 11 illustrates an example in which a spot size of a signal beam that is incident on a photodetector is measured and a tilt of a holographic recording medium is measured.

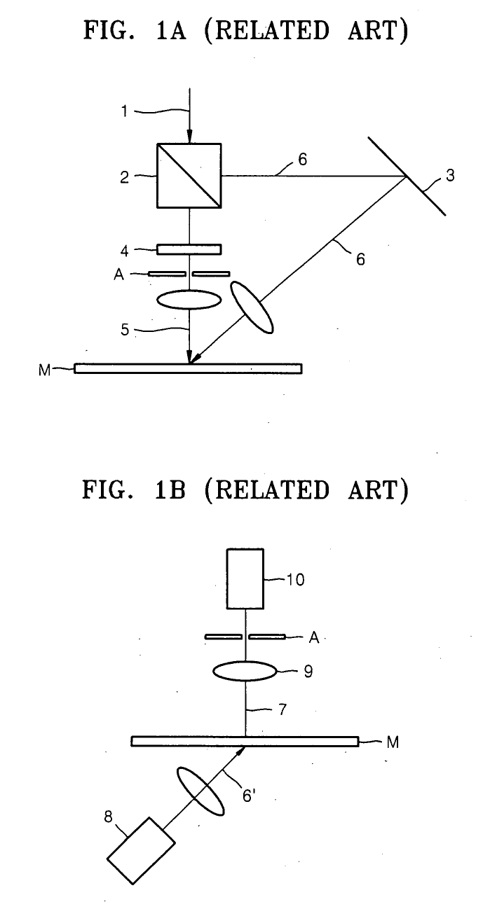

### DETAILED DESCRIPTION OF THE EMBODIMENTS

Reference will now be made in detail to the example embodiments of the present invention, examples of which are illustrated in the accompanying drawings, wherein like reference numerals refer to the like elements throughout. The example embodiments are described below in order to explain the present invention by referring to the figures.

When information is reproduced with a holographic information recording/reproducing apparatus, an aperture plate (i.e., a device that controls admission of light) for restricting the width of a signal beam is disposed in an optical path of the signal beam that is reproduced. By way of the aperture plate, only the portion of the signal beam of a desired book passes through the aperture plate while those of the other books are cut off since the cross-section of a reproducing reference beam (which will generate the signal beam) that is incident on a holographic recording medium is generally larger than a size of one book and causes adjacent books in the vicinity of a desired book to be also reproduced. When books of the holographic recording medium are accurately sought (ascertained or determined), only the desired signal beam (or a portion thereof) that is reproduced from the desired book will pass through the opening of the aperture plate and the signal beams that is reproduced from the adjacent books in the vicinity of the desired book will be symmetrically incident on the circumferences of (or an annular area adjacent) the opening of the aperture plate. However, when positions of the desired books that are to be reproduced cannot be exactly located, positions of the reproduced signal beams that are incident on the aperture plate will be shifted along a desired or predetermined direction.

Example embodiments of the present invention are based on the above and allow positions of the various books to be accurately sought (ascertained or determined) by installing a detector, such as a photodetector, around the opening of the aperture plate, and detecting the position movement of a signal beam (or a portion thereof) that is generated from the adjacent book that is adjacent to the desired book to be recorded and/or reproduced.

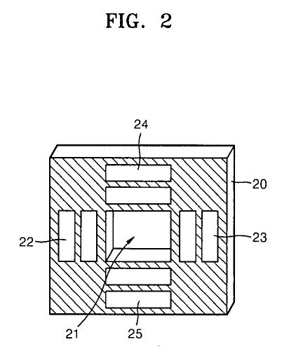

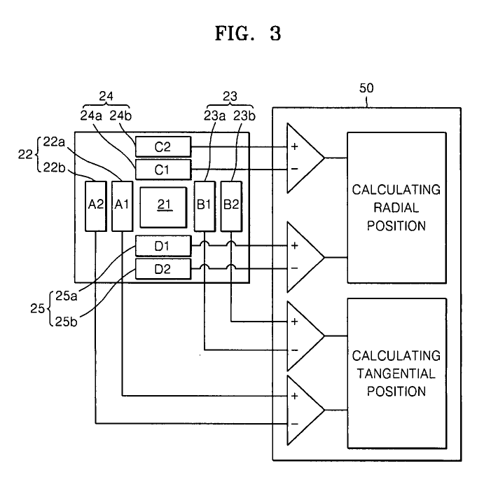

Turning now to FIG. 2, the structure of an aperture plate of a holographic information recording/reproducing apparatus according to an example embodiment of the present invention is illustrated. According to the example embodiment of the present invention, as illustrated in FIG. 2, a plurality of photodetectors 22 through 25 to detect signal beams (or portions thereof) generated from the adjacent books are installed on the surface of the aperture plate 20 along the circumference of (or an annular area adjacent) an opening 21 through which a signal beam (or a portion thereof) generated from a book to be reproduced is passed. In FIG. 2, four photodetectors 22 through 25 are respectively installed adjacent to each of the four sides of the rectangular opening 21. However, the shape of the opening 21 is not necessarily limited to a rectangular shape. In other example embodiments, the shape of the opening 21 may correspond to the shapes of the books within a holographic recording medium. In addition, the type, the number, and/or the positioning of the photodetectors are not limited thereto. In other example embodiments, two photodetectors may be respectively disposed in a respective position that are perpendicular to each other and centered on the opening 21. For example, in FIG. 2, only two photodetectors 22 and 24 out of the four shown may be installed on the surface of the aperture plate 20. In order to more accurately seek the positions of the books, for example, each portion (or segment) of the photodetector may be disposed on each side of the opening 21 along a radial direction of the holographic recording medium and each portion (or segment) photodetector may be disposed on each side of the opening 21 along a tangential direction.

In addition, in order to exactly (or more accurately) measure the degree of shift of the signal beams that are incident on the photodetectors 22, 23, 24, and 25 as illustrated in FIG. 2, the photodetectors 22, 23, 24, and 25 may be two-divided (or paired) photodetectors that are divided into two segments (or portions), for example. As shown, the dividing direction of the two-divided photodetectors 22, 23, 24, and 25 correspond to a direction of an opposing side of the opening 21. For example, as shown in FIG. 2, the photodetectors 22 and 23 that are positioned to oppose each other along a longitudinal side of the opening 21 are divided in a longitudinal direction thereof, and the photodetectors 24 and 25 that are positioned to oppose each other along a latitudinal side of the opening 21 are divided in a latitudinal direction thereof, though not required. In various example embodiments, the segments are arranged symmetrically on the surface of the aperture plate.

A method for seeking positions of books using the aperture plate 20 illustrated in FIG. 2 will now be described in greater detail with reference to FIG. 3. Referring to FIG. 3, four photodetectors 22, 23, 24, and 25 are disposed on the circumference of (or the annular area adjacent) the opening 21 of the aperture plate 20. Here, it is assumed that the two two-divided photodetectors 22 and 23 are disposed along (or relative to) the tangential direction of the holographic recording medium, and the other two two-divided photodetectors 24 and 25 are disposed along (or relative to) the radial direction of the holographic recording medium. In this case, the two-divided photodetectors 22 and 23 that are disposed along the tangential direction should be slightly inclined (or off alignment) to coincide with positions of books that may be arranged along a circular track of the holographic recording medium. However, in FIG. 3, for explanatory conveniences, the two-divided photodetectors 22 and 23 are shown as being disposed along a straight line (or in alignment). However, when a holographic recording medium has a rectangular shape, the two two-divided (or two paired) photodetectors 22 and 23 will be arranged along a straight line in a latitudinal direction, and the other two two-divided (or two paired) photodetectors 24 and 25 will be arranged along a straight line in a longitudinal direction. In other example embodiments, the arrangement of the various example photodetectors 22 and 23 and/or photodetectors 24 and 25 may be arranged in other ways, such as along a curve. In other example embodiments, the photodetectors 24 and 25 may also not be aligned along a line, but may be shifted relative to each other.

In the example embodiment shown in FIG. 3, a signal beam (or a portion thereof generated from a book to be reproduced (the desired book) passes through the opening 21, and signal beams (or portions thereof) generated from four books (the adjacent books) in the vicinity of the desired book are incident on the four two-divided photodetectors 22, 23, 24, and 25, respectively. Accordingly, the four two-divided photodetectors 22, 23, 24, and 25 can measure the intensity of the respective signal beams. As illustrated in FIG. 3, the intensity of each of the signal beams measured by the respective four two-divided photodetectors 22, 23, 24, and 25 is inputted to a book position calculating unit 50 (a book position calculator or a detector). The book position calculating unit 50 calculates the positions of the adjacent books from the outputs of the two-divided photodetectors 22, 23, 24, and 25. More specifically, the book position calculating unit 50 can calculate a book position error from a difference in the intensities of the signal beams respectively measured in the two segments of each of the two-divided photodetectors 22, 23, 24, and 25.

For example, when the intensities of signal beams respectively measured by the two segments 22a and 22b of the photodetector 22 are A1 and A2, the book position calculating unit 50 can calculate a value (a position error (A=A2−A1)) of a book disposed on the left side of the opening 21 in the tangential direction. If A=0, it is regarded (or determined) that there is no book position error. If A has a positive (+) value, it is regarded that the holographic recording medium is inclined (shifted or off position) to the left side along the tangential direction, and if A has a negative (−) value, it is regarded the holographic recording medium is inclined (shifted or off position) to the right side along the tangential direction. Similarly, when the intensities of the signal beams respectively measured by the two segments 23a and 23b of the photodetector 23 are B1 and B2, the book position calculating unit 50 can calculate a value(a position error (B=B2−B1)) of a book disposed on the right side in the tangential direction. If B=0, it is regarded (or determined) that there is no book position error. If B has a positive (+) value, it is regarded that the holographic recording medium is inclined to the right side along the tangential direction, and if B has a negative (−) value, it is regarded that the holographic recording medium is inclined to the left side along the tangential direction. As shown, when the holographic recording medium has a position error only in the tangential direction, A and B will have almost the same absolute value. If there is a large difference in the absolute values (or the values of the intensities of the signal beams) between A and B, it can be expected that an error, such as eccentricity, occurs in the holographic recording medium. Thus, values A and B are calculated by using the book position calculating unit 50 and are fed back thereto so that the holographic recording medium can be moved accordingly.

A position error in the radial direction of the holographic recording medium can be calculated from a difference in the intensities of signal beams that are respectively measured in each of two segments 24a and 24b and 25a and 25b of the photodetectors 24 and 25. For example, when the intensities of the signal beams that are respectively measured by the two segments 24a and 24b of the photodetector 24 are C1 and C2, the book position calculating unit 50 can calculate a value of (a position error (C=C2−C1)) of a book disposed on the upper side of the opening 21 in the radial direction. If C=0, it is regarded (or determined that) that there is no book position error. If C has a positive (+) value, it is regarded that the holographic recording medium is inclined to the upper side of the opening 21 along the radial direction, and if C has a negative (−) value, it is regarded that the holographic recording medium is inclined to the lower side of the opening 21 along the radial direction. Similarly, when the intensities of signal beams respectively that are measured by the two segments 25a and 25b of the photodetector 25 are D1 and D2, the book position calculating unit 50 can calculate a value of (a position error (D=D2−D1)) of a book disposed on the lower side of the opening 21 in the radial direction. According to the example aspect of the present invention, the positions of the books can be accurately ascertained and traced by a feed back loop to obtain a value of 0 for the values A, B, C, and D, as discussed above.

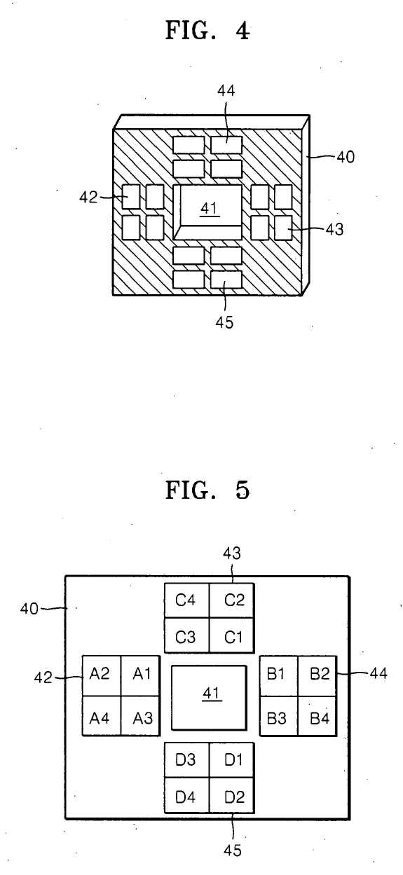

In the above, an example embodiment where two-divided photodetector is used has been described. However, for greater accuracy during seeking, photodetectors with more segments may be used. FIG. 4 illustrates an aperture plate 40 in which photodetectors provided with four-divided (or quad) segments are installed. Referring to FIG. 4, four photodetectors 42, 43, 44, and 45 each having four-divided (or quad) segments are disposed on the circumference (or an annular area adjacent) of an opening 41 of the aperture plate 40. In various example embodiments, the segments are arranged symmetrically on the surface of the aperture plate.

In the example embodiment of FIG. 5, when the intensities of the signal beams (or portions thereof) that are respectively measured by the four segments of the photodetector 42 are A1, A2, A3, and A4, the book position calculating unit 50 can calculate both a tangential position error and a radial position error of a book that is disposed on the left side of the opening 41 in the tangential direction can be calculated as follows. That is, the radial position error of the book that is disposed on the left side of the opening 41 in the tangential direction can be calculated from a difference A3+A4−A1−A2 (i.e., (A3+A4)−(A1+A2)) between the sum A1+A2 of the intensities A1 and A2 of the corresponding signal beams measured by the two segments of the four-divided photodetector 42 arranged along the tangential direction, and the sum A3+A4 of the intensities A3 and A4 of the signal beams measured by the other two corresponding segments. In addition, the tangential position error of the book disposed on the left side of the opening 41 in the tangential direction can be calculated from a difference A2+A4−A1−A3 (i.e., (A2+A4)−(A1+A3)) between the sum A1+A3 of the intensities A1 and A3 of the signal beams measured by the two corresponding segments of the four-divided photodetector 42 arranged along the radial direction and the sum A2+A4 of the intensities A2 and A4 of the signal beams measured in the other two corresponding segments.

Similarly, when the intensities of the signal beams that are respectively measured by the four segments of the photodetector 43 are B1, B2, B3, and B4, the book position calculating unit 50 can calculate a tangential position error and/or a radial position error of a book that is disposed on the right side of the opening 41 in the tangential direction. In addition, by using the intensities C1, C2, C3, and C4 of the signal beams that are respectively measured by the four corresponding segments of the photodetector 44, and the intensities D1, D2, D3, and D4 of the signal beams that are respectively measured by the four corresponding segments of the photodetector 45, a tangential position error and/or a radial position error of each of the book disposed on the upper side of the opening in the radial direction and the book disposed on the lower side of the opening 41 in the radial direction can be calculated (or determined).

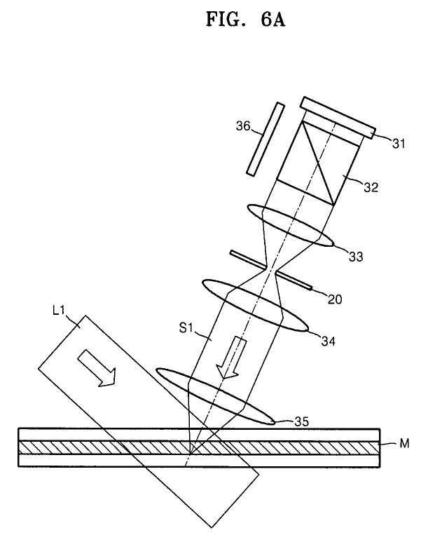

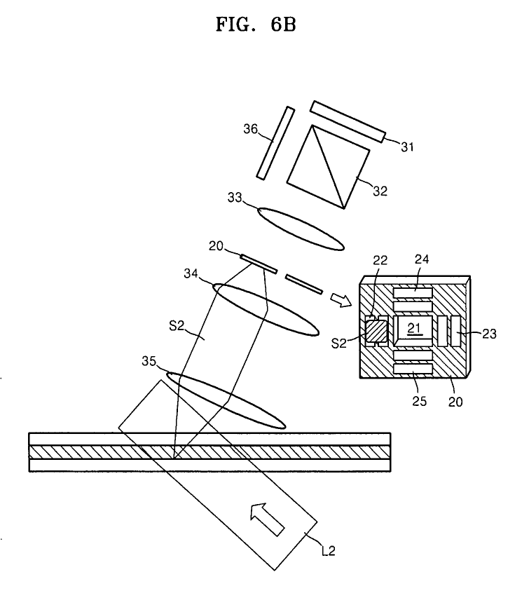

FIGS. 6A and 6B illustrate an operation of selecting (or seeking) a position of a book to be recorded when information is recorded in or reproduced from a holographic recording medium M. First, referring to FIG. 6A, a signal beam S1 modulated by a spatial light modulator (SLM) 31 is condensed by a condensing lens 33 and passes through the aperture plate 20. Then, the signal beam S1 is incident on a holographic recording medium M through a collimating lens 34 and an objective lens 35. In the example embodiment, an interference pattern that is formed when the signal beam S1 and a reference beam L1 interfere with each other is recorded in the holographic recording medium M.

Once the book is recorded in this way, a reference beam L2 for reproduction is made incident from the lower side of the holographic recording medium M while the holographic recording medium M is selectively moved or fixed, as illustrated in FIG. 6B. In various example embodiments, an optical system to generate and detect the signal beams (or a footprint of the book) may also be selectively moved and/or fixed instead of moving and/or fixing the holographic recording medium M. Subsequently, a signal beam S2 reproduced from a book having been recorded just prior thereto, passes through the objective lens 35 and the collimating lens 34 and is incident on the aperture plate 20. As illustrated in the magnification thereof on the right side of FIG. 6B, the signal beam S2 is incident on one photodetector 22 from among the photodetectors 22, 23, 24, and 25 that are installed in the aperture plate 20. The holographic recording medium M moves (or is made to move) until the values of the intensities of the light measured by the two segments of the photodetector 22 are the same by using the previously-described method. The holographic recording medium M stops in a position in which the values of the intensities of the light measured by two segments of the photodetector 22 are the same, and the next book is recorded using the technique illustrated in FIG. 6A. In this way, books can be accurately recorded in specific positions by repeating the operations of FIGS. 6A and/or 6B. In FIGS. 6A and/or 6B, the aperture plate 20 may be replaced with the aperture plate 40, or others.

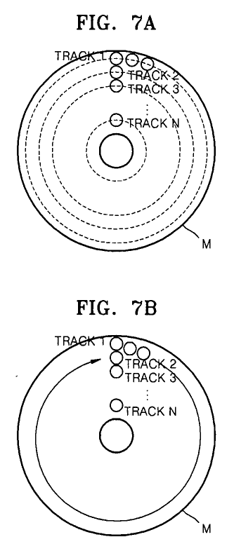

In other example embodiments, when the holographic recording medium M has a circular disc shape, there may be one or more book-recording methods. For example, a book can be recorded along a concentric circular track of the holographic recording medium M, as illustrated in FIG. 7A, and/or a book can be recorded along a spiral track of the holographic recording medium M, as illustrated in FIG. 7B.

In detail, when a book is recorded along the concentric circular track, as illustrated in FIG. 7A, to record a book in the same track, the book is recorded while the holographic recording medium M is moved in the tangential direction based on (or relative to) the book that was recorded just prior thereto. As described above, when a signal beam is incident on the two-divided photodetector 22 of the aperture plate 20, the next book is recorded in a position in which values of the intensities of the light measured by the two segments are the same. When recording in one track is completed in this way, the holographic recording medium M moves in the radial direction based (or relative to) on a book that was recorded just prior thereto and a new book is recorded in the next track. When the holographic recording medium M moves in the radial direction to the next track, for example, a signal beam will be incident on the two-divided photodetector 24 that is disposed on the upper side of the opening 21 of the aperture plate 20. Even in this case, a position in which the values of the intensities of the light measured by the two segments of the two-divided photodetector 24 is the same becomes the position of the next track where the new book will be recorded.

In addition, when books are recorded along a spiral track, as illustrated in FIG. 7B, the holographic recording medium M moves in the tangential direction based on (or relative to) the book that was recorded just prior thereto and the position of the new book to be recorded should be adjusted in the radial direction so that the new book can be recorded in the position of the next track after the holographic recording medium M rotates once. In this case, both of a position error in the tangential direction and a position error in the radial direction should be calculated by using only one signal beam that is generated from the book that was recorded just prior thereto. Thus, in this example embodiment, the aperture plate 40 provided with the four-divided photodetector, as illustrated in FIG. 4, may be used so that the position in which the next book will be recorded is accurately determined in both the tangential direction and the radial direction.

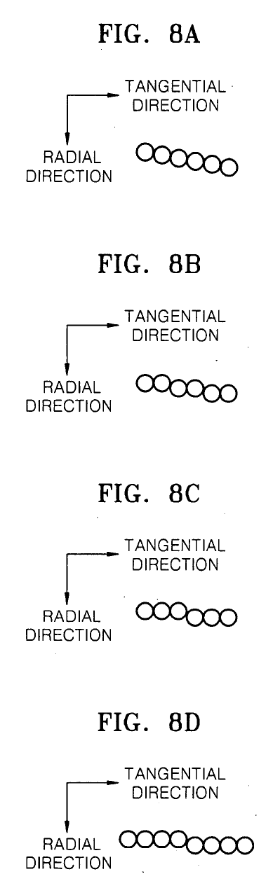

For example, when the size (or dimension) of one book is about 700 μm and the holographic recording medium M is a circular disc having a diameter of about 120 mm, the holographic recording medium M should be moved by about 4 μm from the outermost circumference having a distance of about 58 mm in radius in the radial direction when the holographic recording medium M moves by one book in the tangential direction. The amount of the movement of the holographic recording medium M in the radial direction increases as the recording position on the holographic recording medium M is closer to the inner circumference of the holographic recording medium M. However, when the holographic recording medium M moves by about 4 μm in the radial direction, the resolving power of a stepping motor (not shown) may come into question. In such a case, a usable method is to move the holographic recording medium M only in the tangential direction and then record the several books and then, move the holographic recording medium M in the radial direction and continuously record the several books while the holographic recording medium M moves in the tangential direction. FIGS. 8A through 8D illustrate several example embodiments for recording and/or reproducing, where the holographic recording medium M moves in the radial direction and each book is recorded in the holographic recording medium M for each movement (FIG. 8A), where the holographic recording medium M moves in the radial direction and two books are recorded in the holographic recording medium M for each movement (FIG. 8B), where the holographic recording medium M moves in the radial direction and three books are recorded in the holographic recording medium M for each movement (FIG. 8C), and where the holographic recording medium M moves in the radial direction and four books are recorded in the holographic recording medium M for each movement (FIG. 8D). If the holographic recording medium M moves in the radial direction and ten books are recorded in the holographic recording medium M, the quantity of movement in the radial direction is about 40 μm. Accordingly, a stepping motor (not shown) having a low resolving power may be used.

In this example embodiment, if it is assumed that a signal beam generated from a book having been recorded just before the signal beam is incident on the four-divided photodetector 42 of the aperture plate 40, and if the holographic recording medium M moves only in the tangential direction while the book is recorded in the holographic recording medium M, then the next book is recorded in the holographic recording medium M when a difference A3+A4−A1−A2 between the sum A1+A2 of signal beams measured by two segments arranged along the tangential direction and the sum A3+A4 of signal beams measured by the other two segments is “0” and a difference A2+A4−A1−A3 between the sum A1+A3 of signal beams measured by two segments arranged along the radial direction and the sum A2+A4 of signal beams measured by the other two segments is “0”. When the holographic recording medium M moves in the radial direction and a book is recorded in the holographic recording medium, A2+A4−A1−A3 (i.e., (A2+A4)−(A1+A3)) is “0” in a position in which the next book will be recorded, but A3+A4−A1−A2 (i.e., (A3+A4)−(A1+A2)) will be a predetermined value other than “0”. In this case, the value of A3+A4−A1−A2 (i.e., (A3+A4)−(A1+A2)) in the position in which the next book will be recorded may be determined according to the amount of movement in the radial direction of the holographic recording medium.

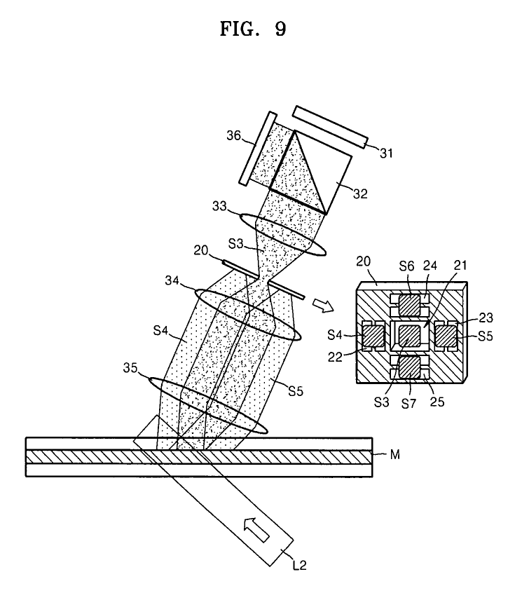

FIG. 9 illustrates a method for seeking positions of books when a book is reproduced during a reproducing operation according to another example embodiment of the present invention. Referring to FIG. 9, a reproducing reference beam L2 having a larger cross-sectional area than a size of one book is incident on the lower side (or a first side) of the holographic recording medium M. Then, signal beams S4, S5, S6, and S7 are generated from books (adjacent books) in the vicinity of a book (desired book) as well for a signal beam S3 generated for the desired book to be reproduced. The signal beams S3, S4, S5, S6, and S7 reproduced in this way are incident on the aperture plate 20, as illustrated in the magnification of the aperture plate 20 located to the right side of FIG. 9. In this example embodiment, the signal beam S3 generated from the desired book to be reproduced, should exactly pass the aperture 21, and should be incident on a two-dimensional photodetector 36, such as a charge coupled device (CCD). To this end, the intensities of the signal beams S4, S5, S6, and S7, that are incident on the four two-divided photodetectors installed (or positioned) in the vicinity of the opening 21, are respectively measured. The position of the holographic recording medium M is controlled based on a difference in the intensities of signal beams measured by the two segments of each of the two-divided photodetectors 22, 23, 24, and 25. The aperture plate 20 having the two-divided photodetectors 22, 23, 24, and 25 is illustrated in FIG. 9 but the aperture plate 40 having the four-divided photodetectors 42, 43, 44, and 45 may also be used instead.

FIG. 10 is a graph showing a difference in the intensities of signal beams detected in two segments of a two-divided photodetector according to a change in positions of books. As indicated on the graph of FIG. 10, a difference in the intensity of light varies nearly linearly according to the position movement of signal beams in the aperture plates 20 and 40. If the aperture plates 20 and 40 and the signal beams are exactly aligned, a difference in the intensity of light is 0. Thus, a position error can be accurately calculated from the difference in the intensities of light. Here, resolution is determined according to the gradient of the graph and the performance of the photodetector. In general, the steeper the gradient of the graph, the higher the resolution. Thus, when recording is performed at regular intervals, absolute values of the difference in the intensities of the signal beams that are measured by the corresponding photodetector disposed on both (or opposite) sides of the opening 21 are added (similar to the example of FIG. 3) so that the gradient of the graph can be made steeper. Accordingly, resolution of about ±30 μm can be obtained.

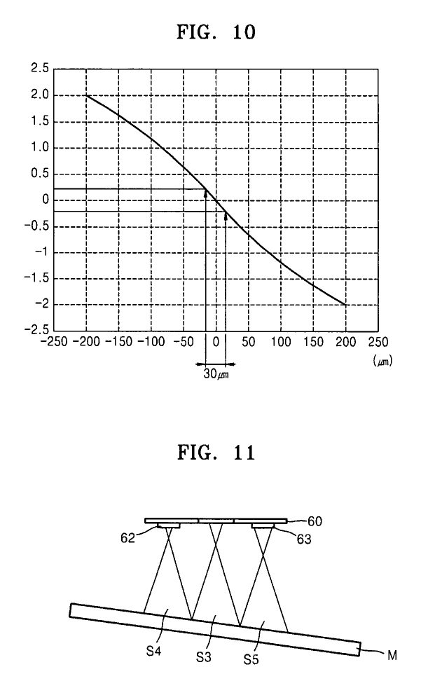

A two-dimensional detector, such as a CCD, may also be used as a photodetector installed in the aperture plates 20, 40. In this example embodiment, the size of a spot of a signal beam incident on the photodetector may also be measured. Thus, a tilt error of the holographic recording medium may also be measured from the difference in the size of the spot of the signal beam. FIG. 11 illustrates an aperture plate 60 in which two-dimensional photodetectors 62 and 63, such as a CCD, are installed, and the holographic recording medium M. As illustrated in FIG. 11, when the holographic recording medium M is not placed in a straight line (level or parallel), the sizes of spots of the signal beams S4 and S5 that are incident on the photodetectors 62 and 63 are different. Thus, according to the example embodiment of the present invention, the sizes of the spots of the signal beams S4 and S5 that are incident on the two-dimensional photodetectors 62 and 63 are respectively measured and are compared so that a tilt error of the holographic recording medium M can be calculated.

According to this example embodiment of the present invention, the detector, such as a CCD photodetector, is installed in the vicinity of the opening of the aperture plate so that a position error of a book to be reproduced can be exactly measured. Thus, since an additional mark does not need to be made on the holographic recording medium, the holographic recording medium can be more simply manufactured. In addition, since an additional optical system does not need to be installed in the holographic information recording/reproducing apparatus, the holographic information recording/reproducing apparatus having a more simple structure and a lower price can be provided. In addition, a tilt error of the holographic recording medium can also be calculated.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the arrangement of the various example photodetectors 22 and 23 and/or photodetectors 24 and 25 may be arranged in other ways, such as along a curve. In other example embodiments, the photodetectors 24 and 25 may also not be aligned along a line, but may be shifted relative to each other. In various example embodiments, the segments of the photo detectors are arranged symmetrically on the surface of the aperture plate.

Accordingly, it is intended, therefore, that the present invention not be limited to the various example embodiments disclosed, but that the present invention includes all embodiments falling within the scope of the appended claims.

What is claimed is:

1. A holographic information recording/reproducing apparatus, the apparatus comprising:
an aperture plate disposed in an optical path of a signal beam reproduced from a reference beam that is incident on a holographic recording medium, and having an opening for restricting a width of the signal beam;
one or more photodetectors installed on a surface of the aperture plate along a circumference of the opening; and
a book position calculator to calculate positions of one or more books based on an output of the photodetectors,
wherein a cross-section of the reference beam incident on the holographic recording medium is larger than the size of the one or more books.

2. The apparatus of claim 1, wherein photodetectors are disposed respectively in positions that are perpendicular to one another relative to the opening.

3. The apparatus of claim 1, wherein the photodetectors are respectively disposed on opposite sides of the opening along a first direction, and on opposite sides of the opening along a second direction that is perpendicular to the first direction.

4. The apparatus of claim 1, wherein each of the photodetectors has two segments arranged symmetrically on the surface of the aperture plate.

5. The apparatus of claim 4, wherein the book position calculator calculates a book position error from a difference in the intensities of the signal beam respectively measured by the two segments.

6. The apparatus of claim 5, wherein the book position calculator calculates the book position error in perpendicular directions using the photodetectors that are disposed perpendicularly to one another.

7. The apparatus of claim 1, wherein the photodetectors each has four segments arranged symmetrically on the surface of the aperture plate.

8. The apparatus of claim 7, wherein the book position calculator calculates a book position error in a second direction perpendicular to a first direction from a difference between the sum of the intensities of the signal beam measured by two of the four segments that are arranged along a first direction and the sum of the intensities of the signal beam measured by the other two of the four segments that are arranged along the first direction, and calculates a book position error in the first direction from a difference between the sum of the intensities of the signal beam measured by two of the four segments that are arranged along the second direction and the sum of the intensities of the signal beam measured by the other two of the four segments that are arranged along the second direction.

9. The apparatus of claim 1, wherein the photodetectors are two-dimensional photodetectors.

10. The apparatus of claim 9, wherein the book position calculator calculates a tilt error of the holographic recording medium from a difference in sizes of optical spots respectively measured by two segments of each of the two-dimensional photodetectors respectively disposed on opposite sides of the opening.

11. A method of seeking positions of books of a holographic recording medium in a holographic information recording/reproducing apparatus, the method comprising:
generating a signal beam from a reference beam that is incident on a holographic recording medium, and having a larger cross-section than a size of one of the books;
detecting the signal beam generated from the books that are adjacent to a desired book to be ascertained, using one or more photodetectors; and
calculating a book position error from an output of the photodetectors,
wherein the photodetectors are installed on a surface of an aperture plate along a circumference of an opening of the aperture plate for restricting a width of the signal beam.

12. The method of claim 11, wherein the photodetectors are respectively disposed on opposite sides of the opening along a first direction, and on opposite sides of the opening along a second direction that is perpendicular to the first direction.

13. The method of claim 11, wherein each of the photodetectors has two segments arranged symmetrically on the surface of the aperture plate.

14. The method of claim 13, wherein a book position error is calculated from a difference in the intensities of the signal beam respectively measured by the two segments.

15. The method of claim 14, wherein a book position error is calculated in perpendicular directions using the photodetectors that are disposed perpendicularly to one another.

16. The method of claim 11, wherein the photodetectors each has four segments arranged symmetrically on the surface of the aperture plate.

17. The method of claim 16, wherein a book position error in a second direction perpendicular to a first direction is calculated from a difference between the sum of the intensities of the signal beam measured by two of the four segments that are arranged along a first direction and the sum of the intensities of the signal beam measured by the other two of the four segments that are arranged along the first direction, and a book position error in the first direction is calculated from a difference between the sum of the intensities of the signal beam measured by two of the four segments that are arranged along the second direction and the sum of the intensities of the signal beam measured by the other two of the four segments that are arranged along the second direction.

18. The method of claim 11, wherein the photodetectors are two-dimensional photodetectors.

19. The method of claim 18, further comprising calculating a tilt error of the holographic recording medium from a difference in sizes of optical spots respectively measured by two segments of each of the two-dimensional photodetectors respectively disposed on opposite sides of the opening.

20. A method of seeking positions of books to be recorded on a disc-shaped holographic recording medium, the method comprising:
recording one of the books in the holographic recording medium;
generating a signal beam from a reference beam having a larger cross-section than a size of one of the books on a holographic recording medium;
detecting the signal beam generated from one of the books that is recorded just prior to the detecting of the signal beam, using one or more photodetectors; and
determining a position of a book to be recorded next, from an output of the photodetector,
wherein the photodetectors are installed on a surface of an aperture plate along a circumference of an opening of the aperture plate for restricting a width of the signal beam.

21. The apparatus of claim 1, wherein the books are two-dimensional regions which are units for recording to and/or reproducing information from the holographic recording medium.

22. An apparatus to record and/or reproduce a book to/from a disc-shaped holographic recording medium, comprising:
a light source to emit a reference beam and a signal beam having a larger cross-section than a size of a preexisting book on the holographic recording medium;
an aperture plate disposed in an optical path of the signal beam and having an opening for restricting a width of the signal beam;
photodetectors installed on a surface of the aperture plate along a circumference of the opening; and
a book detector to detect the presence of the preexisting book through the signal beam generated from the preexisting book based on an output from the photodetectors, and determine a position of a book to be recorded and/or reproduced next from the detected presence of the preexisting book.

23. A method of recording and/or reproducing a book to/from a disc-shaped holographic recording medium, the method comprising:
generating a reference beam and a signal beam having a larger cross-section than a size of a preexisting book on the holographic recording medium;
detecting the presence of the preexisting book through the signal beam generated from the preexisting book by using an output of a photodetector;
determining a position of a book to be recorded and/or reproduced next from the detected presence of the preexisting book; and
recording and/or reproducing the book, wherein the photodetectors are installed on a surface of an aperture plate along a circumference of an opening of the aperture plate for restricting a width of the signal beam.
